(19) United States
(12) Patent Application Publication
(10) Pub. No.: US 2010/0257551 A1
(43) Pub. Date: Oct. 7, 2010

(54) DYNAMIC VIDEO CONTENT

(75) Inventors: Jeffrey Sweeney, Olathe, KS (US); Kelsyn D.S Rooks, Overland Park, KS (US); Jeffrey Stafford, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/416,270

(22) Filed: Apr. 1, 2009

(51) Int. Cl. H04N 7/025; H04N 7/173

(52) U.S. Cl. 725/34; 725/115; 725/109

(57) ABSTRACT

Embodiments of the disclosed invention include a system and method for providing customized video content to a viewer. For example, in one embodiment, the method includes analyzing a video file for identifying a geometric shape associated with a replaceable item within the video file. The method selects from a database a second item corresponding to the geometric shape of the replaceable item based on information associated with a user profile of the viewer. The method overlays a respective viewable portion of the second item on top of a respective viewable portion of the replaceable item within the video file to generate a new video file. The method transmits the new video file to the viewer.

### BACKGROUND OF THE INVENTION

The disclosed invention is related to the field of providing video content, and in particular to providing videos customized for a particular viewer or a group of viewers.

### SUMMARY

Embodiments of the disclosed invention include a system and method for providing customized video content to a viewer. For example, in one embodiment, the method includes analyzing a video file for identifying a geometric shape associated with a replaceable item within the video file. The method selects from a database a second item corresponding to the geometric shape of the replaceable item based on information associated with a user profile of the viewer. The method overlays a respective viewable portion of the second item on top of a respective viewable portion of the replaceable item within the video file to generate a new customized video file. The method transmits the customized video file to the viewer.

### BRIEF DESCRIPTION OF THE DRAWINGS

Illustrative embodiments of the present invention are described in detail below with reference to the attached drawing figures, which are incorporated by reference herein and wherein:

FIG. 1 depicts an embodiment a network environment in which the illustrative embodiments may be implemented;

FIG. 2 depicts an embodiment of a media server in accordance with the illustrative embodiments;

FIG. 3 illustrates an example of identifying and replacing a geometric shape associated with a replaceable item within a video file; and

FIG. 4 depicts an embodiment of a process performed by a media server for providing customized video content to a viewer in accordance with the illustrative embodiments.

### DETAILED DESCRIPTION

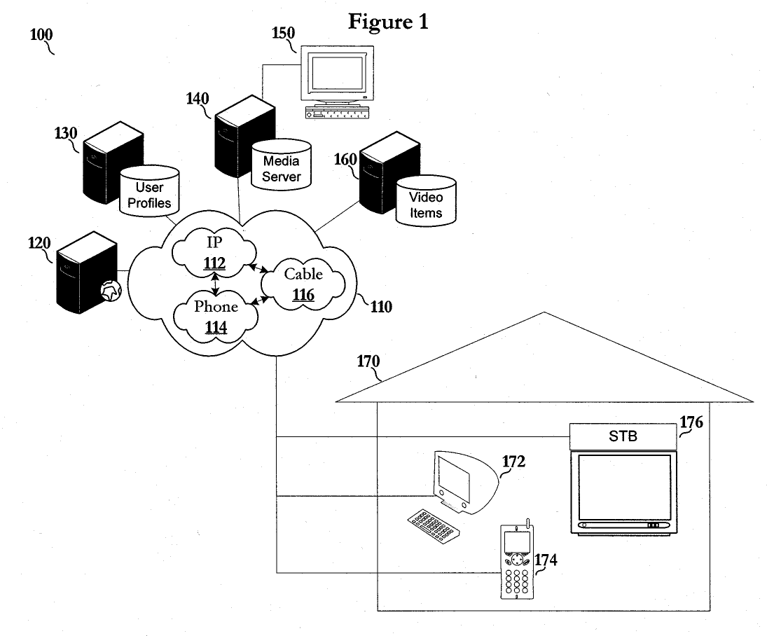

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented.

FIG. 1 depicts an embodiment a network environment 100 in which the illustrative embodiments may be implemented. In the depicted embodiment, network environment 100 includes a plurality of devices that provide services, such as, but not limited to, video and Internet services to one or more client devices via communication network 110. In one embodiment, communication network 110 may include one or more networks, such as, but not limited to, an IP network 112, telephone network 114, and cable network 116 for providing services to a plurality of devices.

IP Network 112 may include one or more data networks, such as, but not limited to, the Internet, for routing communications between one or more communication devices and/or data processing systems. The Internet is a global system of interconnected computer networks that interchange data using the standardized Internet Protocol Suite (TCP/IP). Additionally, IP Network 112 may include other types of data networks, such as, but not limited to, an intranet, a private local area network (LAN), a wide area network (WAN), and a wireless local area network (WLAN). In one embodiment, IP Network 112 may communicate with one or more networks, such as, but not limited to, telephone network 114 and cable network 116 for providing services to a plurality of subscribers.

In some embodiments, telephone network 114 may include a public switched telephone network (PSTN). The public switched telephone network is the standard analog telephone network utilized by most homes. In addition, in some embodiments, telephone network 114 may also include digital telephone networks, such as, but not limited to, an integrated services digital network (ISDN) and a fiber distributed data interface (FDDI) network. Additionally, in some embodiments, telephone network 114 may include one or more cellular networks, such as, but not limited to, a Global System for Mobile Communications (GSM) network, a Code-Division Multiple Access (CDMA) network, an Enhanced Data GSM Environment (EDGE) network, and a 3G/4G network.

Cable network 116 may include, but not limited to, one or more coaxial cable networks, fiber-optic networks, twisted pair networks, and/or satellite networks. In some embodiments, cable network 116 supplies television/video content to a plurality of subscribers including, but not limited to, residential location 170.

In accordance with one embodiment, a web server 120 may provide access to online web videos, such as, but not limited to, online videos posted by other users, online news stories, and/or online TV shows provided by a television network, to a plurality of devices via communication network 110, such as, but not limited to, a client data processing system 172 and/or a smart mobile phone 174. For instance, in some embodiments, web server 120 may communicate with a media server 140 for providing the requested videos. In some embodiments, media server 140 may provide additional video services, such as, but not limited to, cable TV services and/or IPTV services to a plurality of subscriber devices via communication network 110, such as, but not limited to, set-top box 176 located at residential location 170. IPTV is a service that delivers television content to the viewer through data networks instead of being delivered through traditional broadcast and cable formats. IPTV is typically supplied by a service provider using a closed network infrastructure controlled and engineered by the service provider to ensure efficient bandwidth to deliver vast amounts of multicast video traffic. For instance, in one embodiment, media server 140 may be located at a cable head end and/or a central office associated with a service provider.

In accordance with the disclosed embodiments, media server 140 may communicate with one or more devices to generate a customized video based on a user profile associated with one or more viewers. For example, in one embodiment, media server 140 may analyze a video file to identify replaceable items in the video file using image recognition. For instance, in one embodiment, media server 140 may be configured to recognize particular geometric shapes associated with a particular item and compare the images associated with the recognize shapes to known items for identifying the item. In some embodiments, media server 140 may be communicatively coupled to a data processing system 150 for enabling a user to manually assist media server 140 by adjusting and/or selecting recognized shapes/items in a video file.

In addition, in accordance with one embodiment, media server 140 may communicate with a user profiles database system 130 for retrieving a user profile associated with one or more recipients of the video file. In one embodiment, media server 140 may select one or more video data objects from database system 160 based on information contained in the user profile for overlaying the selected items over the corresponding identified replaceable items in a video file. Similarly, in some embodiments, a user may manually assist media server 140 in selecting the one or more video data objects from database system 160 based on information contained in the user profile.

In other embodiments, media server 140 may select one or more video data objects from database system 160 based on the location of a viewer. For example, in one embodiment, media server 140 may recognize and replace a billboard in a scene of a video with a billboard advertising a local business in the location associated the viewer. Similarly, in some embodiments, media server 140 may select one or more video data objects from database system 160 based on a language associated with the location of a viewer. For instance, in one embodiment, if media server 140 is broadcasting a video to an IP address located in China, the local billboard advertising may be in Chinese.

In addition, in some embodiments, media server 140 may dynamically generate a user profile from information associated with a viewer. For example, in one embodiment, media server 140 may generate a user profile of a viewer based on a web history and/or viewing history associated with the viewer. For instance, in one embodiment, media server 140 may retrieve/receive a web history file from a device, such as, but not limited to, client data processing system 172, smart mobile phone 174, and/or set top box 176 for dynamically generating a user profile of the viewer. For example, the web history file may indicate preferences and/or other information associated with a viewer, such as, but not limited to, a particular brand of merchandise, music preference, and/or the viewer's occupation. In these embodiments, media server 140 may select replacement items specifically targeted towards the viewer. Alternatively, or in addition to, in some embodiments, a user may manually create and/or alter his or her user profile. For example, in one embodiment, a user may access a web page hosted by web server 120 to alter his or her user profile stored on user profiles database system 130.

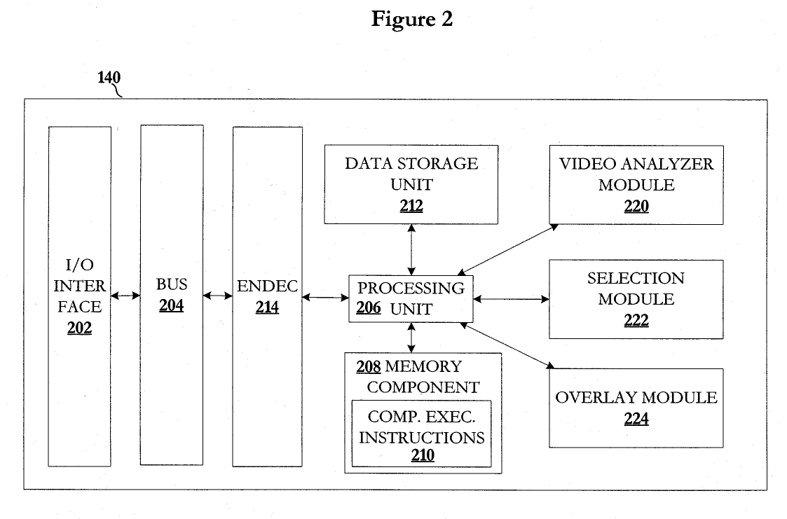

FIG. 2 depicts an embodiment of media server 140 in accordance with the illustrative embodiments. FIG. 2 is not intended to imply and/or restrict the architecture, functionality, and operation of other possible implementations of media server 140 that are within the scope of the disclosed embodiments. For example, other possible implementations of media server 140 may include additional components not depicted in FIG. 2 and/or the deletion/combination of one or more of the illustrated components. In addition, the depicted modules may be take the form of an entirely hardware embodiment, an entirely software embodiment, or an embodiment containing both hardware and software elements. For example, in some embodiments, the disclosed modules may be implemented in software, including, but not limited to, firmware, resident software, and microcode, that are executed by a processor, such as, but not limited to, a processing unit 206.

In the depicted embodiment, media server 140 includes an input/output (I/O) interface 202. In one embodiment, I/O interface 202 may include communication ports for coupling one or more devices to media server 140, such as, but not limited to, a monitor, a keyboard, and a mouse. In some embodiments, I/O interface 202 may include one or more data ports, such as, but not limited to, a USB port. In addition, in some embodiments I/O interface 202 may include a network interface card, such as, but not limited to, an Ethernet card for connecting media server 140 to a network, such as, but not limited to, communication network 110. Alternatively, or in addition to, in some embodiments, I/O interface 202 may include a wireless transceiver for communicating data wirelessly.

In one embodiment, data received from I/O interface 202 is communicated to other components of media server 140, such as, but not limited to, processing unit 206, via a system bus 204. System bus 204 provides conductive pathways/traces to mechanically support and electrically connect the various components of media server 140 for enabling features, such as, video processing and storage.

Processing unit 206 serves to execute computer executable instructions, such as, but not limited to, computer executable instructions 210 stored in memory component 208. Processing unit 206 may be a set of one or more processors or may be a multi-processor core, depending on the particular implementation. Further, processing unit 206 may be implemented using one or more heterogeneous processor systems in which a main processor is present with secondary processors on a single chip. In some embodiments, processing unit 206 may be a symmetric multi-processor system containing multiple processors of the same type.

Memory component 208 is a volatile memory component of media server 140. Volatile memory is memory that loses its contents when power is lost. For example, in one embodiment, memory component 208 may be random access memory (RAM). Random access memory stores currently executing computer executable instructions, such as, computer executable instructions 210, and/or other data associated with an operating system, hardware device, and/or other software applications.

In addition, in some embodiments, media server 140 may include one or more data storage units 212. Data storage unit 212 is non-volatile memory that retains stored data until deleted. For instance, in some embodiments, data storage unit 212 may store a library of video files, such as, but not limited to, movies, television shows, and commercials. In some embodiments, data storage unit 212 may be, but is not limited to, a hard drive, a flash memory, a rewritable optical disk, a rewritable magnetic tape, and/or some combination of the above. Additionally, in some embodiments, data storage unit 212 may be removable, such as, a removable hard drive and/or an external hard drive.

In accordance with one embodiment, media server 140 may include a video analyzer module 220. In one embodiment, video analyzer module 220 may include instructions for analyzing a video file for recognizing particular geometric shapes and identifying the items associated with the recognized geometric shapes. For example, in one embodiment, video analyzer module 220 may be configured to identify box shape images in a kitchen scene, such as, but not limited to, a cereal box. In some embodiments, video analyzer module 220 may compare an identified box shape image to known products for identifying the item associated with the identified shape. Further, in some embodiments, media server 140 may present an identified shape/object on a monitor for receiving assistance from a user in identifying the object.

Additionally, media server 140 may include a selection module 222 for retrieving a user profile and selecting a replacement item based on information associated with the user profile for an identified item in a video file. In one embodiment, selection module 222 may retrieve a user profile from an external user profiles database. In other embodiments, selection module 222 may include computer executable instructions for generating user profile information dynamically using a web history file associated with a viewer. In one embodiment, selection module 222 may receive annual assistance from a user for selecting a replacement item based on information associated with the user profile. In other embodiments, selection module 222 may automatically select a replacement item based on information associated with the user profile. As an illustrative example, suppose video analyzer module 220 identifies a Brand X cereal box used during a kitchen scene in a movie. In one embodiment, selection module 222 may determine from information associated with a user profile of a viewer that the viewer is located in an area that Brand X is not commonly available. In this example, selection module 222 may automatically select a cereal brand but is available in the area associated with the viewer.

Additionally, in some embodiments, media server 140 may include an overlay module 224 for overlaying an image of a newly selected item on top of an identified replaceable item in a video file. For instance, using the previous example, overlay module 224 may overlay an image of a Brand Y cereal on top of the image of the Brand X cereal and generate a new video file with the image of the Brand Y cereal replacing the image of the Brand X cereal. In addition, in some embodiments, overlay module 224 determines, extracts, and overlays only a respective viewable portion of the replaced item. For instance, in the above example, if the Brand X cereal box is being handled by a person during the kitchen scene (i.e., someone is carrying the Brand X cereal box), overlay module 224 must determine and extract only the viewable portions of the Brand X cereal box and overlay only the respective viewable portions of the Brand Y cereal box for generating the new video file.

Further, in some embodiments, media server 140 may include an endec (encoder/decoder) module 214 for encoding the customized video based on one or more video formats, including, but not limited to, Moving Picture Experts Group (MPEG) format (e.g., MPEG-2 and MPEG-4/MP4), Flash media formats, Windows Media Video (WMV) format, and Audio Video Interleave (AVI) format. In one embodiment, media server 140 may determine a type of receiving device being utilized by a viewer for encoding the customized video specifically for the intended device. For example, in one embodiment, if the recipient device is a mobile/smart phone or PDA, media server 140 may encode the customized video using Audio Video Interleave (AVI) for conserving data storage/memory usage.

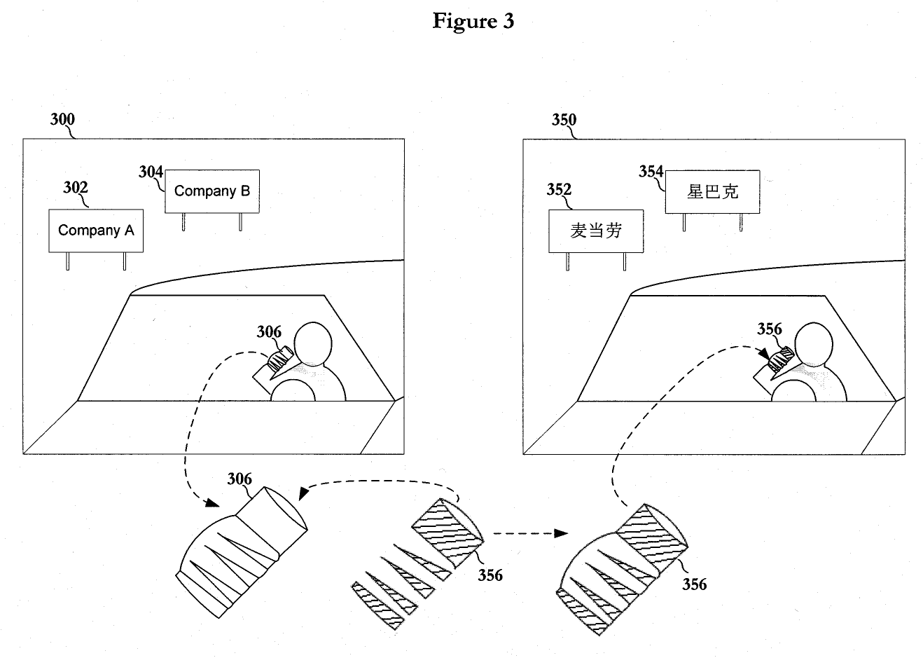

FIG. 3 illustrates an example of identifying and replacing one or more geometric shape items within a video file. For instance, in the depicted embodiment, screen 300 illustrates an original screen image associated with a video file. In one embodiment, media server 140 analyzes screen 300 and identifies geometric shapes/objects 302, 304, and 306 as possible items that may replaced in screen 300. For example, in one embodiment, media server 140 may highlight the border of the recognized shapes for enabling a user to manually select and/or adjust a selected item. In addition, in some embodiments, media server 140 may utilize the surrounding environment associated with a selected geometric shape and/or may compare an image associated with the selected geometric shape with known images for identifying the particular selected item. For example, in one embodiment, media server 140 may utilize the surrounding images of a road and a vehicle to determine that geometric shapes/objects 302 and 304 are billboard displays alongside a road. In addition, in one embodiment, media server 140 may recognize a cylindrical object in a person's hand, such as geometric shape 306, as some type of beverage container.

In accordance with the disclosed embodiments, in response to identify a geometric shape/object that may be replaced within a video file, media server 140 may replace the respective viewable portion of an identified geometric shape/object with the respective viewable portion of another image having the same geometric shape for customizing the video towards a particular user profile of a viewer. For example, in the illustrative embodiment, the respective viewable portion of geometric shape 306 is overlapped and replaced with the respective viewable portion of geometric shape 356 depicting a different image. For instance, the video associated with screen 300 may have been originally made in the United States and intended for an English-speaking audience. The video is now being translated into Chinese for a Chinese audience. In such an embodiment, media server 140 may replace particular items in the video for making the product placement of items in the video more relevant to a Chinese audience/viewer. For example, geometric shapes/objects 302 and 304 may be replaced with objects 352 and 354 depicting billboards advertising Chinese companies and geometric shape 306 may be replaced with geometric object 356 depicting a popular drink in China.

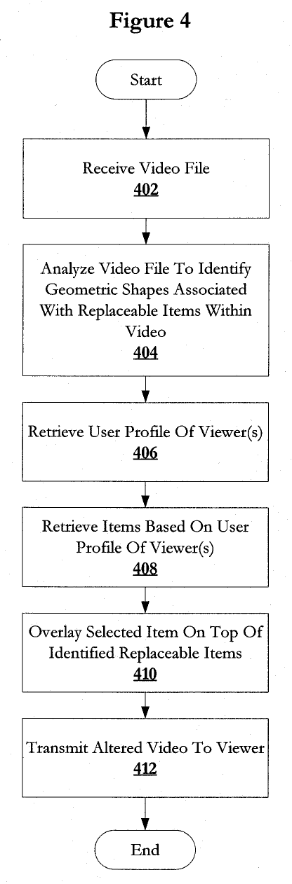

FIG. 4 depicts an embodiment of a process 400 performed by a media server for providing customized video content to a viewer in accordance with the illustrative embodiments. Process 400 begins, at step 402, by receiving an input video file. At step 404, the process analyzes the video file for identifying geometric shapes associated with objects that may be replaceable within the video file. In some embodiments, a user may manually assist process 400 by selecting, deselecting and/or adjusting particular identified geometric shape. The process, at step 406, retrieves a user profile associated with an intended viewer of the video file. For example, in one embodiment, the process may retrieve a user profile from a user profile database. For instance, in one embodiment, the user profile may have been previously created by the viewer. In other embodiments, the process may dynamically generate user profile information using, but not limited to, a viewer's web history and/or a viewer's location, e.g., IP address and/or physical address associated with a subscriber.

At step 408, the process retrieves/selects one or more replacement items based on information associated with the user profile. For example, in one embodiment, the process may select a number of replacement items that may replace an identified geometric shape/object in the video. In these embodiments, the process may present/display the replacement items on a screen for a user to manually select a desired replacement item. In other embodiments, the process may automatically select a particular item for replacing an identified geometric shape/object based on the user profile.

The process, at step 410, determines the respective viewable portion of the identified geometric shape/object and overlaps the corresponding respective viewable portion of a selected replacement item on top of the identified geometric shape/object. In one embodiment, the process creates a new/altered video file containing the selected replacement item in place of the prior geometric shape/object. At step 412, the process transmits the new customized video file to the perspective viewer, with process 400 terminating thereafter.

Accordingly, the disclosed embodiments present a system and method for providing customized video content to a user based on a user profile. Advantages of the disclosed include, but are not limited to, enabling multiple versions of a video file to be created without having to actually shoot multiple times. In addition, the disclosed embodiments enable a video file that was not created using green screen technology to be dynamically updated with more recent products and/or advertising. Further, the disclosed embodiments enable the replacement of items within a video file to target a specific viewer and/or audience.

As will be appreciated by one skilled in the art, certain aspects of the disclosed embodiments may be embodied as a system, method, or computer program product. In addition, the disclosed embodiments including, but not limited to, the disclosed modules may be implemented entirely with hardware or as a software embodiment (including firmware, resident software, micro-code, etc.) or an embodiment combining software and hardware aspects. Furthermore, the disclosed embodiments may take the form of a computer program product embodied in any tangible medium of expression having computer-usable program code embodied in the medium.

The disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions. In addition, the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which may include one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Additionally, computer program instructions for executing the disclosed embodiments may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a data processing apparatus to cause a series of operational steps to be performed on the data processing system to produce a computer implemented process such that the instructions which execute on the data processing system provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” ate intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The disclosed embodiments were chosen to explain the principles of the invention and the practical application, and to enable others of ordinary skill in the art to understand the invention for various embodiments with various modifications as are suited to the particular use contemplated.

We claim:

1. A method for creating customized video content for a viewer, the method comprising:
identifying a first image of a geometric shape from a video file, the geometric shape associated with a replaceable item;
selecting from a database a second image of a second item associated with the geometric shape, the second image being selected in response to information associated with a user profile of the viewer;
overlaying a respective viewable portion of the second image on top of a respective viewable portion of the first image within the video file; and
generating a new video file containing the second image overlaid over the first image.

2. The method of claim 1, further comprising transmitting the new video file to the viewer.

3. The method of claim 1, further comprising dynamically generating the user profile of the viewer based on information included in a web history file associated with the viewer.

4. The method of claim 1, further comprising receiving data for generating the user profile from the viewer.

5. The method of claim 1, wherein selecting from the database the second item corresponding to the geometric shape of the replaceable item is based on location information associated with the user profile of the viewer.

6. The method of claim 1, wherein selecting from the database the second item corresponding to the geometric shape of the replaceable item is based on a language associated with the user profile of the viewer.

7. The method of claim 1, wherein the steps of analyzing, selecting, and overlaying are performed for a plurality of replaceable items.

8. The method of claim 1, wherein analyzing the video file for identifying a geometric shape associated with a replaceable item within the video file is performed with manual assistance.

9. The method of claim 1, wherein selecting from a database a second item corresponding to the geometric shape of the replaceable item based on information associated with a user profile of the viewer is performed with manual assistance.

10. The method of claim 1, further comprising encoding the new video file in a media file format compatible with a recipient device associated with the viewer.

11. A media server configured to create customized video content for a viewer, the media server comprising:
a video analyzer module operable to identify a first image of a geometric shape from a video file;
a selection module operable to select from a database a second image of a second item associated with the geometric shape, the second image being selected in response to information associated with a user profile of the viewer; and
an overlay module operable to overlay a respective viewable portion of the second image on top of a respective viewable portion of the first image within the video file to generate a new video file.

12. The media server of claim 11, further comprising a network interface for transmitting the new video file to the viewer.

13. The media server of claim 11, further comprising an encoder module for encoding the customized video based on a type of recipient viewing device.

14. The media server of claim 11, further comprising:
the network interface receiving a web history file associated with the viewer; and
a processing unit that executes computer executable instructions for dynamically generating the user profile of the viewer based information included in a web history file associated with the viewer.

15. The media server of claim 11, further comprising:
the network interface receiving manually inputted data from the viewer; and
a processing unit that executes computer executable instructions for generating the user profile of the viewer from the manually inputted data.

16. The media server of claim 11, further comprising the selection module selecting from the database the second item corresponding to the geometric shape of the replaceable item based on location information associated with the user profile of the viewer.

17. The media server of claim 11, further comprising the selection module selecting from the database the second item corresponding to the geometric shape of the replaceable item is based on a language associated with the user profile of the viewer.

18. The media server of claim 11, further comprising the video analyzer module receiving external assistance from a user for identifying the geometric shape associated with the replaceable item within the video file.

19. The media server of claim 11, further comprising the selection module receiving external assistance from a user for selecting from the database the second item corresponding to the geometric shape of the replaceable item based on information associated with the user profile of the viewer.

20. A computer program product comprising a computer usable medium, said computer usable medium storing computer usable program code for:
identifying a replaceable item within the video file;
selecting from a database a new item based on information associated with a user profile of the viewer; and
overlaying a respective viewable portion of the new item on top of a respective viewable portion of the replaceable item within the video file to generate a new video file.
